(19) United States
(12) Patent Application Publication
(10) Pub. No.: US 2007/0031311 A1
(43) Pub. Date: Feb. 8, 2007

(54) Regeneration of calcium oxide or calcium carbonate from waste calcium sulphide

(76) Inventors: Edward J. Anthony, Ottawa (CA); Kuanrong Qiu, Nepean (CA); Lufei Jia, Kanata (CA)

Correspondence Address: SHAPIRO COHEN, P.O. BOX 3440, STATION D, OTTAWA, ON, K1P6P1, CA

(21) Appl. No.: 11/542,165

(22) Filed: Oct. 4, 2006

Related U.S. Application Data
(63) Continuation-in-part of application No. 11/011,599, filed on Dec. 15, 2004.
Application No. 11/011,599 is a continuation-in-part of application No. 10/600,345, filed on Jun. 23, 2003, now abandoned.

(51) Int. Cl. B01D 53/48

(52) U.S. Cl. 423/244.05

(57) ABSTRACT

An alternative process whereby the calcium sulphide formed in an IGCC system from calcium oxide and/or calcium carbonate can be safely and more or less quantitatively converted by reaction with carbon dioxide to calcium carbonate and/or calcium oxide together with sulphur dioxide The calcium oxide and/or calcium carbonate can be reused in the IGCC system, and the sulphur dioxide can be converted to a useful product, such as sulphuric acid. One result of this process is that since the furnace ashes do not contain a significant level of calcium sulphide, they can be safely disposed of in a land fill site.

This is a continuation-in-part of U.S. Ser. No. 11/011,599 filed Dec. 15, 2004 which is a continuation-in-part of U.S. Ser. No. 10/600,345 filed Jun. 23, 2003.

### BACKGROUND

In the past, coal has commonly been used as a fuel in electrical power generation. Although the details have changed with time, in a coal fired power station the coal is generally burnt under oxidising conditions in a boiler unit to generate steam, which is then used to operate a turbine driven generator. Although this technology is reasonably well understood, it is still not without its drawbacks. If the coal is burnt under conditions which optimise coal consumption, and also if the coal contains significant amounts of sulphur, oxides of both sulphur and nitrogen are formed, which result in ecological damage.

Techniques for removing acid oxides from flue gases, particularly sulphur oxides, are known. The commonly used one is to add a particulate calcium compound, such as calcium carbonate, or calcium oxide(lime) to the coal so as to trap the sulphur oxides as calcium sulphite and/or calcium sulphate. However, the utilisation of the calcium compound in the furnace is relatively inefficient.

Alternatives to full sized power stations have been proposed. One of these is the so-called “Integrated Gasification Combined Cycle” (hereafter IGCC) technique. The IGCC technique is attractive for producing electricity from coal because of its low emissions level and its significantly improved fuel efficiency in comparison with a conventional coal fired power station. In a power generation unit using IGCC, the coal is gasified under reducing conditions, the resulting gas is burnt with air as the oxygen source and the resulting hot gas is used to power a gas turbine. The gas turbine drives the generating equipment, which can be mounted directly onto the same shaft as the gas turbine itself

However, the IGCC technique is not without its own disadvantages, one of which is that the sulphur is still present in the coal, and thus can be present in the hot gas being burnt to power the gas turbine. Due to the different conditions in the two systems, the presence of sulphur in the fuel poses a quite different problem in an IGCC system to that found in a conventional steam generating furnace.

IGCC systems involve a coal gasification step which is carried out in a gasifier under reducing conditions. Due to the different chemical conditions involved in the gasifier, instead of producing sulphur oxides in the hot gas, the sulphur is present chiefly as hydrogen sulphide, H₂S. The hydrogen sulphide must be largely removed, first due to the limit on the amount of sulphur that can be accepted in the gases going forward to the turbine stage, and second due to the toxicity of hydrogen sulphide.

The step normally taken to capture the hydrogen sulphide is to react it with a calcium compound, by adding typically powdered calcium oxide(lime) or limestone to the IGCC reactor. In the reactor, the powdered limestone reacts to produce mainly calcium sulphide, according to essentially the following reaction:
CaCO₃+H₂S→CaS+H₂O+CO₂ (1)

This ash product cannot be sent to a landfill site, because reaction of ground water with the calcium sulphide produces poisonous hydrogen sulphide. At a practical level, almost quantitative destruction of the calcium sulphide is required before the ashes can be disposed of safely in a landfill site

To destroy the calcium sulphide and to enhance process efficiency, it has been proposed to burn the ash product remaining from the coal gasification process, which will include calcium sulphide, calcium oxide, ash materials (from the coal or other carbonaceous feed material), and unburnt char, with air in a so-called topping cycle combustor, which is typically a pressurised fluidized bed combustor (hereafter PFBC) or preferably a circulating fluidized bed combustor (hereafter CFBC). In the PFBC or CFBC topping cycle, in theory the calcium sulphide should be oxidised to calcium sulphate, more or less as proposed by Wheelock in U.S. Pat. No. 5,228,399 and by Moss, in U.S. Pat. No. 4,435,148. According to both of these patents, when calcium sulphide is burnt under the correct conditions of oxygen partial pressure and temperature, reaction (2) takes place.
CaS+2O₂→CaSO₄ (2)

It has been shown that reaction (2) does not go to completion as proposed in these two patents: Qiu et al., in Ind. Eng. Chem. Res. 37, 923-928 (1998) showed that as the calcium sulphide is oxidised the calcium sulphate is formed as a relatively hard crust of calcium sulphate on the surface of the calcium sulphide particles. Qiu et al. showed that once this hard crust has formed, the rate of oxidation of the calcium sulphide inside the calcium sulphate crust is controlled by the rate at which oxygen can be transported through the calcium sulphate crust into the calcium sulphide core of the particle. Qiu et al. showed that the oxygen transfer rate is far too slow for the process to be of any commercial usefulness.

Proposals have been made to overcome this difficulty, for example by Wheelock in U.S. Pat. No. 4,102,989; in U.S. Pat. No. 5,653,955 and in U.S. Pat. No. 6,083,862, and by Turkdogan in U.S. Pat. No. 4,370,161 In these patents either very carefully controlled conditions are used (eg '955) or at least one additional reagent is added to the gas (eg '862 and '161).

This invention seeks to overcome these difficulties, and to provide an alternative two stage process whereby the calcium sulphide formed in an IGCC system can be safely and more or less quantitatively converted to other sulphur compounds which can be trapped and used for other useful purposes.

In the process according to this invention several potentially competing reactions can occur; these are:
CaCO₃+H₂S→CaS+H₂O+CO₂ (1)
CaCO₃→CaO+CO₂ (3)
CaO+H₂S→CaS+H₂O (4)
CaS+2CO₂→CaO+SO₂+2CO (5)

It is noticeable that none of these reactions produce any significant amounts of calcium sulphate.

Since the reaction conditions are chosen so that the calcium sulphide produced in these reactions is not oxidised to calcium sulphate, the creation of a tightly adhering calcium sulphate crust on the particles of calcium sulphide is avoided, thus allowing the reaction producing sulphur dioxide, for example Reaction (5), to go more or less to completion. The resulting ash product can be disposed of safely in a land fill site.

### SUMMARY OF THE INVENTION

Thus in its broadest embodiment, this invention seeks to provide a process for removing sulphide compounds from an exhaust gas flow from a first gasifier furnace in which a carbon containing fuel which also contains sulphur, is consumed under reducing conditions, which process comprises.
(a) providing in the furnace fuel an amount of at least one compound chosen from the group consisting of limestone, calcium oxide and mixtures thereof, sufficient to trap the sulphide compounds in the gas flow as calcium sulphide;
(b) recovering the calcium sulphide as part of a first ash product from the first gasifier furnace;
(c) reacting the first ash product in a second reactor furnace with sufficient carbon dioxide at a partial pressure and at a temperature sufficient to convert the calcium sulphide in the ash product to at least one compound chosen from the group consisting of calcium carbonate, calcium oxide, and a mixture thereof, to provide a gas flow containing sulphur dioxide;
(d) recovering the sulphur dioxide; and
(e) recovering a substantially calcium sulphide free second ash product from the second reactor furnace.

Preferably, the desired carbon dioxide partial pressure is obtained by using a mixture of carbon dioxide and nitrogen.

Preferably, the first gasifier furnace fuel is a fossil fuel. More preferably, the first gasifier furnace fuel is coal.

Preferably, the first gasifier furnace is operated according to the integrated gasification combined cycle technique (IGCC).

Preferably, the second reactor furnace is chosen from the group consisting of a pressurised fluidised bed combustor (PFBC) and a circulating fluidised bed combustor (CFBC).

Preferably, the second reactor furnace is operated at a temperature of about 850° C. to about 980° C.

Preferably, in step (c) at least 90% of the calcium sulphide present in the first ash product is converted to calcium carbonate and/or calcium oxide.

Preferably, in step (c) a mixture of carbon dioxide and nitrogen is used to obtain the desired carbon dioxide partial pressure.

### BRIEF DESCRIPTION OF THE DRAWINGS

The invention will now be described in more detail with reference to the attached Figures in which;

FIG. 1 shows schematically an experimental furnace used to investigate the reaction of calcium sulphide with carbon dioxide;

FIG. 2 shows data for the oxidation of calcium sulphide by carbon dioxide;

FIG. 3 shows data for the oxidation of calcium sulphide by carbon dioxide in the presence of water;

FIG. 4 shows data for the reaction of calcium sulphide with water in the presence of nitrogen;

FIG. 5 shows data for the oxidation of calcium sulphide by carbon dioxide over a long time period.

FIG. 6 shows the chemical equilibrium phase diagram of the Ca—S—O—C system at a temperature of 1100° C. under weak reducing conditions.

### DETAILED DESCRIPTION

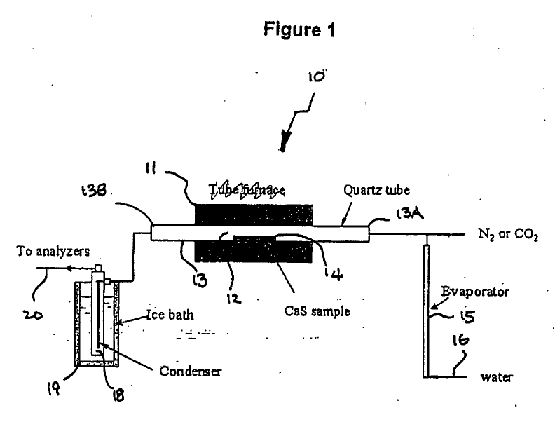

Referring first to FIG. 1, the experimental furnace 10 comprises a tubular electric furnace 11 which heats the midportion 11 of a quartz tube 13. The sample of calcium sulphide was placed in a small ceramic boat 14, which was then located at more or less the center of the furnace 11. At the input end 13A of the quartz tube nitrogen or carbon dioxide was fed in to the quartz tube 11 through line 15, to which was attached and evaporator fed with a controlled flow water through line 16. At the output end 13B of the quartz tube the exiting gases in Line 17 were first passed through a condenser 18 cooled by an ice bath 19 and then passed through line 20 to the analytical equipment(not shown).

In operation, a sample of calcium sulphide having a particle size of less than about 45 μm is placed in the ceramic boat and the system flushed for about 20 minutes with carbon dioxide or carbon monoxide The carbon dioxide used had total impurities of less than 100 ppm and therefore contained negligible amounts of oxygen. The carbon dioxide flow rate was generally maintained at about 0.6 dm³/min. During some of the tests the effect of water vapour was also investigated. The carbon dioxide flow rate was increased to 1 dm³/min. the water flow rates was controlled by a syringe pump at 0.1 dm³/min.

The tube furnace used was capable of reaching 850° C. in about 30 minutes. For this furnace construction the temperature differential between the calcium sulphide sample and the quartz tube is negligible. The gas in line 20 was fed to carbon monoxide and sulphur dioxide NDIR analyser.

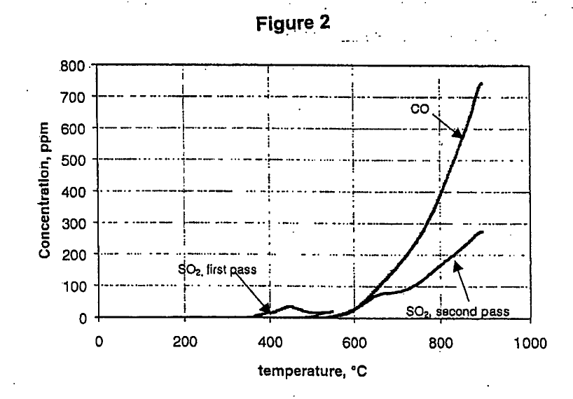

FIGS. 2, 3, 4, and 5 show the data from a test runs in which a calcium sulphide sample was oxidised under varying conditions. The calcium sulphide used was obtained from Aldrich Chemicals, and on analysis was found to contain 97.1% by weight CaS The conditions for these test runs is shown in Table 1.

TABLE 1

| FIG. | | |
|---|---|---|
| No. | Sample size, g. | Gas composition and flow rate. |
| 2 | 0.3462 | 0.1 dm³/min, CO₂ |
| 3 | 0.3235 | 0.1 dm³/min H₂O + 0.1 dm³/min CO₂ |
| 4 | 0.2090 | 0.05 dm³/min H₂O + 1 dm³/min N₂ |
| 5 | 0.2069 | 1 dm³/min CO₂ |

The test run shown in FIG. 2 was carried out in two passes. In the first pass the furnace was raised from room temperature to about 550° C. and then allowed to cool to near room temperature. When cool, the second pass was made with the furnace heated from near room temperature to about 900° C. This test was run according to reaction (5) above. It then follows that all of the reactant gases, carbon dioxide, carbon monoxide and sulphur dioxide, can be tracked by the analysis system.

In the first pass, a small sulphur dioxide peak occurred in the temperature window of 400° C.-550° C.; this peak did not appear in the second pass. This result indicates that the first sulphur dioxide peak is caused by impurities in the calcium sulphide sample. It is also of interest that the ratio of sulphur dioxide to carbon monoxide at a value of from about 0.4 to about 0.5 within the temperature window of from abut 800° C. to about 850° C. is larger than the stoichiometry of the reactions given above would indicate. This suggests that these simple reactions do not adequately describe the oxidation of calcium sulphide by carbon dioxide.

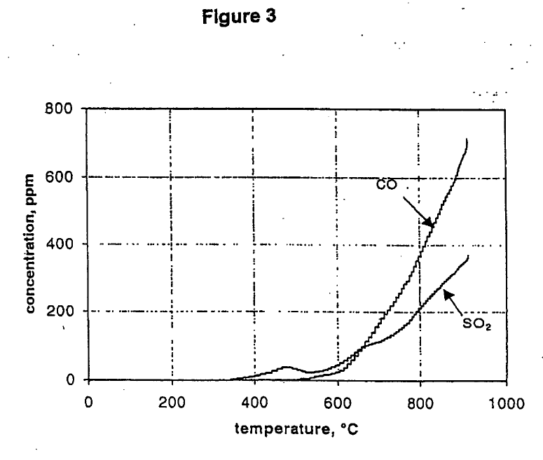

The test run shown in FIG. 3 was carried out to investigate the effect of water on the reaction The carbon monoxide and sulphur dioxide profiles are very similar to those for the reaction of carbon sulphide with carbon dioxide alone. However, the ratio of carbon monoxide to sulphur dioxide is slightly lower; this is probably due to the influence of the water gas shift reactions

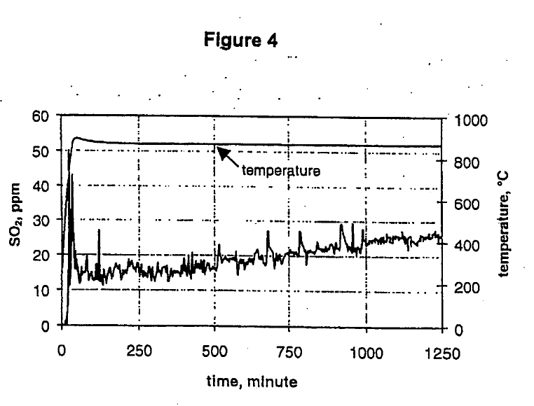

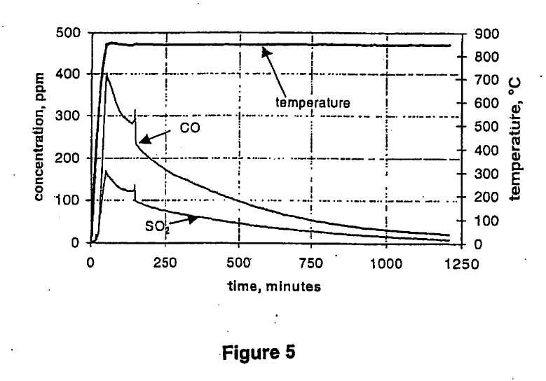

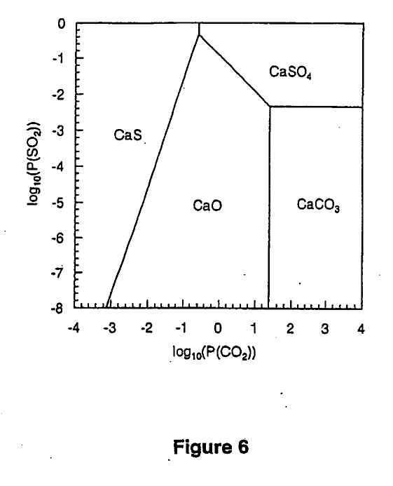

For the test runs shown in FIGS. 4 and 5 the calcium sulphide samples were held for 22 hours at a temperature of 850° C. in streams of water (FIG. 6) and carbon dioxide (FIG. 5) The results of the analysis of the samples by quantitative X-ray diffraction (QXRD) at the end of this period is shown in Table 2.

TABLE 2

| | | Wt % on oxidation | Wt % on oxidation |
|---|---|---|---|
| Phase Identity | Formula | by CO₂ | by H₂O |
| Calcite | CaCO₃ | 92.3 | not present |
| Oldhamite | CaS | 6.7 | 73.2 |
| Lime | CaO | not present | 7.2 |
| Portlandite | Ca(OH)₂ | not present | 19.4 |
| Crystallinity | | 99.0 | 99.8 |
| Amorphous | | 1.0 | 0.2 |
| content | | | |

It is clear from these two much longer runs that oxidation by carbon dioxide is far more effective than oxidation with water over the same temperature range Additionally it is also noteworthy that no calcium sulphate is formed.

The results shown in FIGS. 4 and 5 and in Table 2 are very similar to those shown in the preceding figures, and the presence of multiple peaks is evident throughout the run. It is also notable that the formation of calcium oxide or calcium carbonate is not limited on thermodynamic grounds at a high carbon dioxide concentration and at a high reaction temperature; this possibility is evident from FIG. 6. However, at very high sulphur dioxide and carbon dioxide concentrations or partial pressures calcium sulphate can be formed. In practice, the chemical equilibrium diagram shown in FIG. 6 is used to choose appropriate operating conditions.

These results demonstrate that carbon dioxide oxidation can be used to destroy calcium sulphide more or less completely. There are at least two strategies whereby this reaction can be used. The first is to operate at a temperature above the stability of calcium carbonate with pure carbon dioxide, that is above 900° C. to ensure that the pores in the calcium sulphide particles remain open. The second is to operate at lower temperatures with mixtures of carbon dioxide and nitrogen such that calcium carbonate is not stable at the operating temperature of interest.

We claim:

1. A process for removing sulphide compounds from an exhaust gas flow from a first gasifier furnace in which a carbon containing fuel which also contains sulphur, is consumed under reducing conditions, which process comprises:
(a) providing in the furnace fuel an amount of at least one compound chosen from the group consisting of limestone, calcium oxide and mixtures thereof, sufficient to trap the sulphide compounds in the gas flow as calcium sulphide;
(b) recovering the calcium sulphide as part of a first ash product from the first gasifier furnace;
(c) reacting the first ash product in a second reactor furnace with sufficient carbon dioxide at a partial pressure and at a temperature sufficient to convert the calcium sulphide in the ash product to at least one compound chosen from the group consisting of calcium carbonate, calcium oxide, and a mixture thereof, to provide a gas flow containing sulphur dioxide;
(d) recovering the sulphur dioxide; and
(e) recovering a substantially calcium sulphide free second ash product from the second reactor furnace.

2. A process according to claim 1 wherein the first gasifier furnace fuel is a fossil fuel.

3. A process according to claim 2 wherein the first gasifier furnace fuel is coal.

4. A process according to claim 1 wherein the first gasifier furnace is operated according to the integrated gasification combined cycle technique (IGCC).

5. A process according to claim 1 wherein the second reactor furnace is chosen from the group consisting of a pressurised fluidised bed combustor (PFBC) and a circulating fluidised bed combustor (CFBC).

6. A process according to claim 1 wherein the second reactor furnace is operated at a temperature of from about 850° C. to about 980° C.

7. A process according to claim 1 wherein in step (c) at least 90% of the calcium sulphide present in the first ash product is converted to at least one compound chosen from the group consisting of calcium carbonate and calcium oxide.

8. A process according to claim 1 wherein in step (c) of claim 1 a mixture of carbon dioxide and nitrogen is used to obtain the desired carbon dioxide partial pressure.

9. A process according to claim 8 wherein the first gasifier furnace fuel is a fossil fuel.

10. A process according to claim 9 wherein the first gasifier furnace fuel is coal.

11. A process according to claim 8 wherein the first gasifier furnace is operated according to the integrated gasification combined cycle technique (IGCC).

12. A process according to claim 8 wherein the second reactor furnace is chosen from the group-consisting of a pressurised fluidised bed combustor (PFBC) and a circulating fluidised bed combustor (CFBC).

13. A process according to claim 8 wherein the second reactor furnace is operated at a temperature of from about 850° C. to about 980° C.

14. A process according to claim 8 wherein in step (c) at least 90% of the calcium sulphide present in the first ash product is converted to at least one compound chosen from the group consisting of calcium carbonate and calcium oxide.
